(19) United States
(12) Patent Application Publication
(10) Pub. No.: US 2016/0036680 A1
(43) Pub. Date: Feb. 4, 2016

(54) PACKET MONITORING METHOD, PACKET MONITORING APPARATUS, AND STORAGE MEDIUM

(71) Applicant: FUJITSU LIMITED, Kawasaki-shi (JP)

(72) Inventor: Keiji MIYAZAKI, Kawasaki (JP)

(73) Assignee: FUJITSU LIMITED, Kawasaki-shi (JP)

(21) Appl. No.: 14/717,337

(22) Filed: May 20, 2015

(30) Foreign Application Priority Data
Jul. 30, 2014 (JP) 2014-155463

(51) Int. Cl. H04L 12/26; H04L 29/08; H04L 29/06

(52) U.S. Cl. CPC H04L 43/0894; H04L 69/28; H04L 67/22; H04L 67/02

(57) ABSTRACT

A packet monitoring method includes storing acquisition time indicating time when a packet including the transmission source information and the destination information is obtained lastly, and a first counter value into a first memory, in association with a combination of transmission source information and destination information of a plurality of packets; receiving a first packet; extracting acquisition time associated with a combination of transmission source information and destination information included in the first packet from the first memory; determining whether a time period from the extracted acquisition time to acquisition time of the first packet is shorter than a predetermined time; and increasing the first counter value stored in the first memory and associated with the combination of transmission source information and destination information included in the first packet by a predetermined value when it is determined that the time period is shorter than the predetermined time.

### CROSS-REFERENCE TO RELATED APPLICATION

This application is based upon and claims the benefit of priority of the prior Japanese Patent Application No. 2014-155463, filed on Jul. 30, 2014, the entire contents of which are incorporated herein by reference.

### FIELD

The embodiments discussed herein are related to a packet monitoring method, a packet monitoring apparatus, and a storage medium.

### BACKGROUND

Operators of electronic commerce (EC) sites are interested in which products and services published on their EC sites attract users' attention. As one of the indicators representing the degree of attention of users, the number of accesses (also called page views) to a Web page in which a products, and the like are displayed is provided. An operator of an EC site makes a response in accordance with the counted number of accesses, such as giving a second thought to the sales strategy of their products, or the like, changing designs of a Web page, and changing the number of servers, or the like, for example.

The number of accesses is obtained, for example by counting the number of requests transmitted from terminals operated by users to a Web server providing Web contents, or the like. A certain document discloses that the number of requests is counted by a load distribution apparatus that relays communication between user terminals and a Web server. However, if the number of requests is simply counted, that number of accesses sometimes does not suitably reflect the degree of attention of users.

For example, as illustrated in FIG. 1, consider the case where a user clicks a mouse to select an area 1001 in a window 1000 on a screen in order to change the contents of the window 1000. Usually, when a user clicks the area 1001 once, one request is transmitted from a user terminal to a Web server, and the accumulated number of accesses is incremented by one.

However, there are cases where a user unintentionally clicks two times or more, or a user clicks several times when it takes time for changing the contents of the window 1000, or the like. In such a case, although the degree of attention of users is the same as that in the previous example, the same number of requests as the number of clicks by the user is transmitted to the Web server. As a result, the accumulated number of accesses is incremented by the number of user's clicks. The above-described document does not pay attention to such problems. As a related art, Japanese Laid-open Patent Publication No. 2003-242110 is disclosed, for example.

### SUMMARY

According to an aspect of the invention, a packet monitoring method executed by a packet monitoring apparatus, the packet monitoring method includes storing acquisition time indicating time when a packet including the transmission source information and the destination information is obtained lastly, and a first counter value into a first memory, in association with a combination of transmission source information and destination information of a plurality of packets; receiving a first packet; extracting acquisition time associated with a combination of transmission source information and destination information included in the first packet from the first memory; determining whether a time period from the extracted acquisition time to acquisition time of the first packet is shorter than a predetermined time; and increasing the first counter value stored in the first memory and associated with the combination of transmission source information and destination information included in the first packet by a predetermined value when it is determined that the time period is shorter than the predetermined time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an EC site;

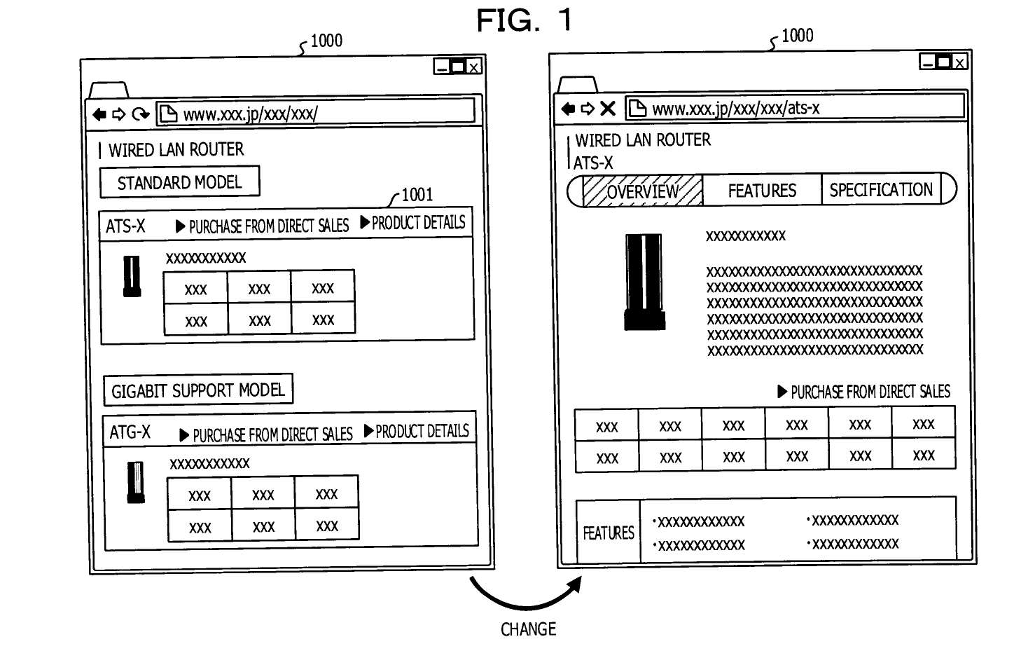

FIG. 2 is a diagram illustrating a system overview according to the present embodiment;

FIG. 3 is a functional block diagram of a monitoring apparatus;

FIG. 4 is a diagram illustrating an example of data stored in a time data storage unit;

FIG. 5 is a diagram illustrating an example of a monitoring table stored in a monitoring table storage unit;

FIG. 6 is a diagram illustrating an example of a request table stored in a request table storage unit;

FIG. 7 is a diagram illustrating a processing flowchart of processing executed when the monitoring apparatus obtains a request;

FIG. 8 is an explanatory diagram of a reference time;

FIG. 9 is an explanatory diagram of a reference time;

FIG. 10 is a diagram illustrating a processing flowchart of processing executed when the monitoring apparatus obtains a request;

FIG. 11 is a diagram for explaining state transition of the monitoring table and the request table;

FIG. 12 is a diagram for explaining state transition of the monitoring table and the request table;

FIG. 13 is a diagram for explaining state transition of the monitoring table and the request table;

FIG. 14 is a diagram for explaining state transition of the monitoring table and the request table;

FIG. 15 is a diagram for explaining state transition of the monitoring table and the request table;

FIG. 16 is a diagram for explaining state transition of the monitoring table and the request table;

FIG. 17 is a diagram for explaining state transition of the monitoring table and the request table;

FIG. 18 is a diagram for explaining state transition of the monitoring table and the request table;

FIG. 19 is a diagram for explaining state transition of the monitoring table and the request table;

FIG. 20 is a diagram illustrating a processing flowchart of processing executed by an output unit of the monitoring apparatus; and

FIG. 21 is a functional block diagram of a computer.

### DESCRIPTION OF EMBODIMENTS

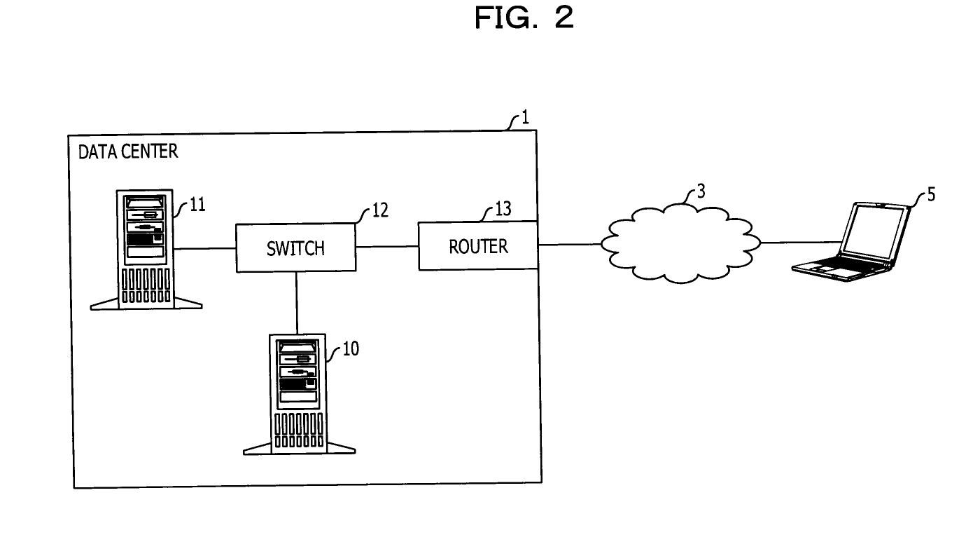

FIG. 2 illustrates a system overview according to the present embodiment. A switch 12 disposed in a data center 1 is coupled to a Web server 11, a monitoring apparatus 10 that performs main processing according to the present embodiment, and a router 13. The router 13 is coupled to a network 3, which is the Internet, for example. A user terminal 5 is coupled to the network 3.

The user terminal 5 transmits a request for executing processing by the Web server 11 to the Web server 11. The request transmitted by the user terminal 5 reaches the router 13 through the network 3. The router 13 transfers a received request to the switch 12. The switch 12 transfers the request received from the router 13 to the Web server 11. The switch 12 includes a mirror port. A copy of the request transferred to the Web server 11 is transferred from the mirror port to the monitoring apparatus 10.

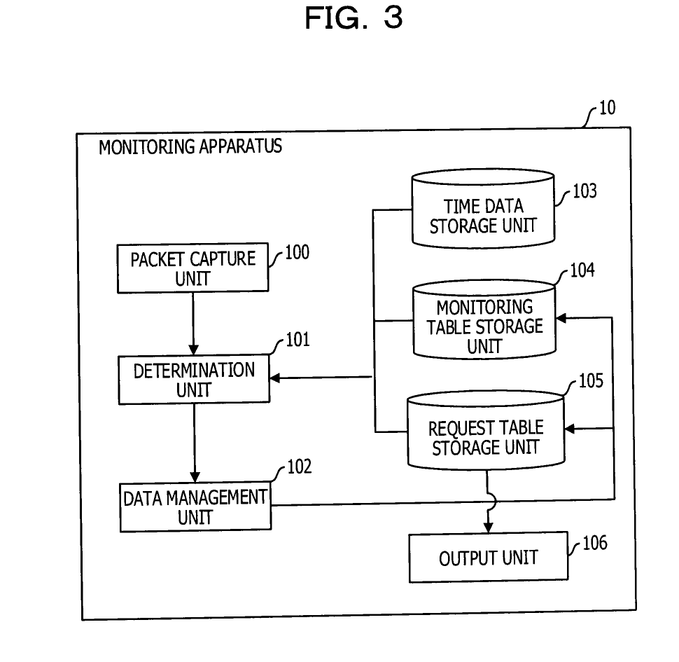

FIG. 3 illustrates a functional block diagram of the monitoring apparatus 10. The monitoring apparatus 10 includes a packet capture unit 100, a determination unit 101, a data management unit 102, a time data storage unit 103, a monitoring table storage unit 104, a request table storage unit 105, and an output unit 106.

The packet capture unit 100 obtains the request that the switch 12 transferred from the mirror port. Then, the packet capture unit 100 outputs the obtained request and request time (hereinafter, called acquisition time) at which the request is obtained to the determination unit 101. The determination unit 101 performs processing using data stored in the time data storage unit 103 and data stored in the monitoring table storage unit 104, and outputs the processing result to the data management unit 102. The data management unit 102 updates the data stored in the monitoring table storage unit 104, and the data stored in the request table storage unit 105 based on the processing result received from the determination unit 101. The output unit 106 reads the data stored in the request table storage unit 105, and outputs the data to the display unit, or the like, for example.

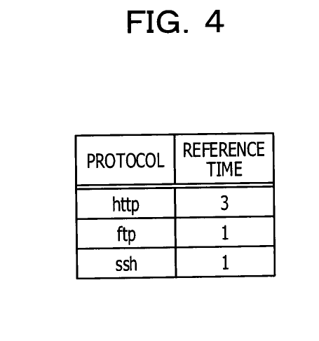

FIG. 4 is illustrates an example of data stored in the time data storage unit 103. In the example in FIG. 4, a protocol identifier, and information indicating reference time are stored in the time data storage unit 103. A detailed description will be given later of the reference time. In FIG. 4, only Hypertext Transfer Protocol (HTTP), File Transfer Protocol (FTP), and Secure Shell (SSH) are illustrated. However, the protocol to be handled may be a protocol other than these protocols.

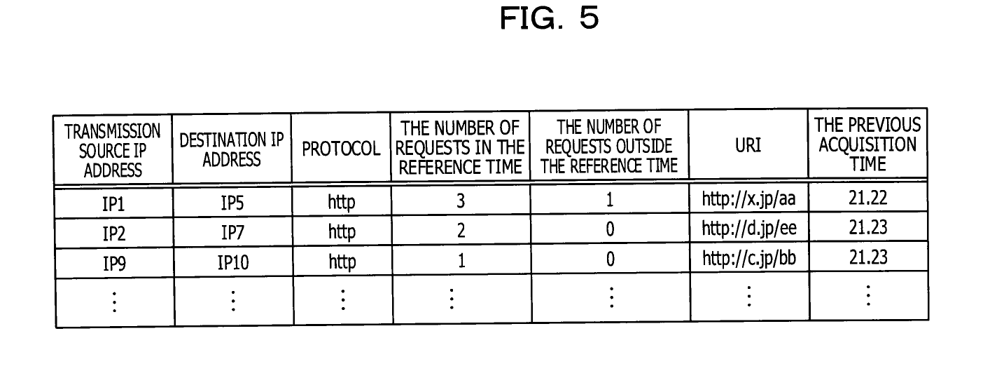

FIG. 5 illustrates an example of a monitoring table stored in the monitoring table storage unit 104. In the example in FIG. 5, a transmission source IP address, a destination IP address, a protocol identifier, the number of requests in the reference time, the number of requests outside the reference time, a uniform resource identifier (URI), and the previous acquisition time are stored in the monitoring table storage unit 104.

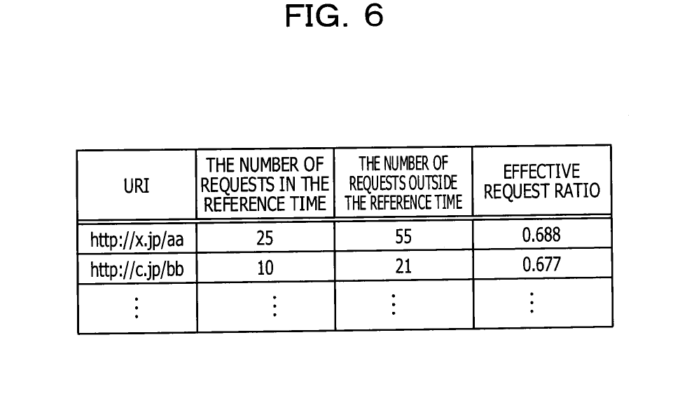

FIG. 6 illustrates an example of a request table stored in the request table storage unit 105. In the example in FIG. 6, a URI, the number of requests in the reference time, the number of requests outside the reference time, and an effective request ratio are stored in the request table storage unit 105. The effective request ratio is calculated by (the number of requests outside the reference time)/((the number of requests in the reference time)+(the number of requests outside the reference time)).

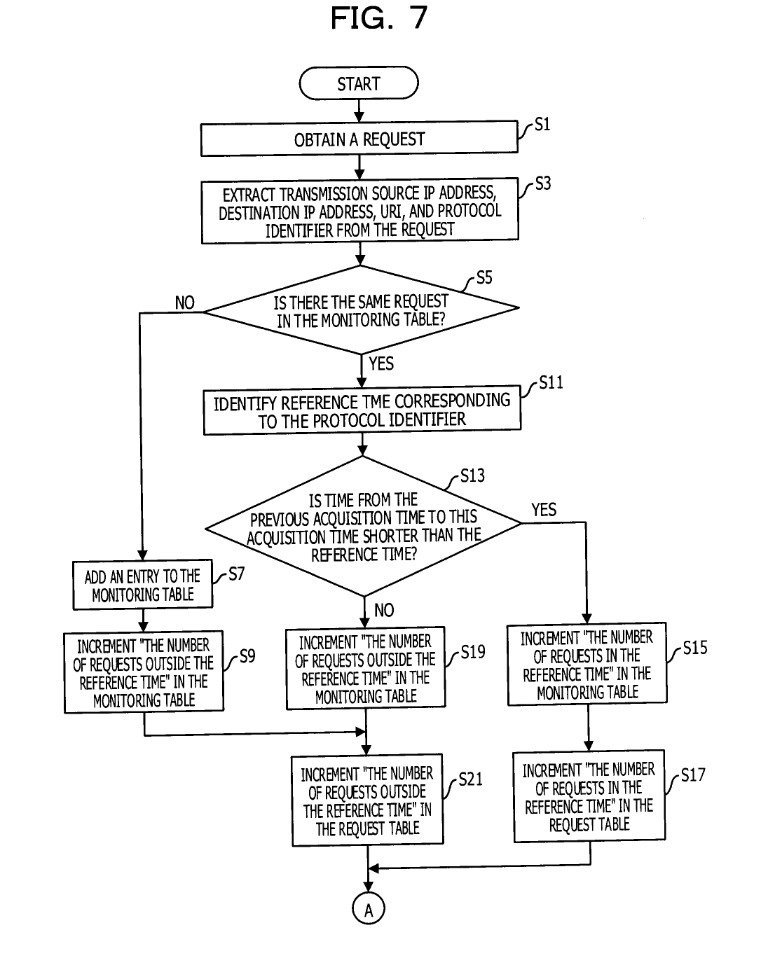

Next, a description will be given of operation of the monitoring apparatus 10 using FIG. 7 to FIG. 20. First, a description will be given of processing performed when the monitoring apparatus 10 obtains a request using FIG. 7 to FIG. 19.

The packet capture unit 100 obtains a request that the switch 12 transferred from the mirror port (FIG. 7: S1). Then, the packet capture unit 100 outputs the obtained request, and the acquisition time to the determination unit 101.

The determination unit 101 extracts a transmission source IP address, a destination IP address, and a URI and protocol identifier from the request received from the packet capture unit 100 (S3).

The determination unit 101 determines whether the entry of request including the transmission source IP address, the destination IP address, and the URI and protocol identifier, which were extracted in S3 is included in the monitoring table or not (S5).

If there are no entries of the requests including the transmission source IP address, the destination IP address, the URI, and the protocol identifier, which were extracted in S3, in the monitoring table (S5: No), the determination unit 101 notifies the determination result to the data management unit 102.

Next, the data management unit 102 adds the entry including, the transmission source IP address, the destination IP address, the URI, and the protocol identifier, which have been extracted in S3, to the monitoring table (S7). In S7, the data management unit 102 sets the acquisition time of the packet obtained in S1 in the field of “the previous acquisition time”. Then, the data management unit 102 sets 0 in the field of “the number of requests in the reference time”, and the field of “the number of requests outside the reference time”.

The data management unit 102 increments “the number of requests outside the reference time” in the monitoring table by one (S9). Then, the processing proceeds to the processing in S21.

On the other hand, if there is an entry (hereinafter, called an entry of processing target) of the request including the transmission source IP address, the destination IP address, and the URI and protocol identifier, which were extracted in S3, in the monitoring table (S5: Yes), the determination unit 101 performs the processing in S11. Specifically, the determination unit 101 identifies a reference time corresponding to the protocol identifier included in the entry of the processing target from the time data storage unit 103 (S11).

The determination unit 101 determines whether time from “the previous acquisition time” in the entry of the processing target to the acquisition time of the packet obtained in S1 is shorter than the reference time identified in S11 (S13).

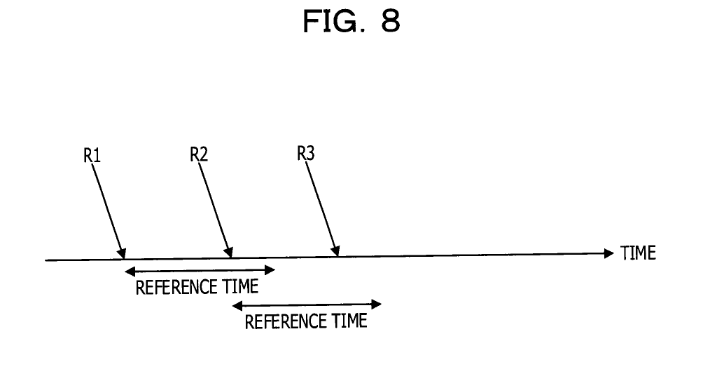

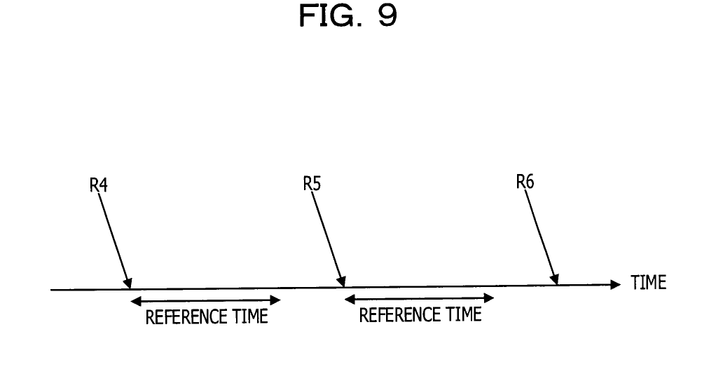

A description will be given of the reference time using FIG. 8 and FIG. 9. In FIG. 8 and FIG. 9, the horizontal axis represents time. Reference symbols R1 to R3 in FIG. 8 are the same requests. Reference symbols R4 to R6 in FIG. 9 are the same requests.

In FIG. 8, R2 is obtained before the reference time has passed from time when R1 is obtained, and thus R2 is a request in the reference time. R3 is obtained before the reference time has passed from time when R2 is obtained, and thus R3 is a request in the reference time. There is a possibility that R2 and R3 were transmitted because a user unintentionally clicked two times or more, or a user clicked many time since it had took time until the contents of a window were changed, or the like, and thus R2 and R3 are handled separately from normal requests.

On the other hand, in FIG. 9, R5 is obtained after the reference time has passed from time when R4 is obtained, and thus R5 is a request outside the reference time. R6 is obtained after the reference time has passed from time when R5 is obtained, and thus R6 is a request outside the reference time. There is a possibility that R5 and R6 were transmitted because a user clicked and browsed a page, then returned to the former page, and clicked again in order to browse the page once again, or the like. Accordingly, R5 and R6 are handled as normal requests.

Returning back to the description of FIG. 7, if time from “the previous acquisition time” in the entry of the processing target to the acquisition time of the packet obtained in S1 is shorter than the reference time identified in S11 (S13: Yes), the determination unit 101 notifies the determination result to the data management unit 102.

In response to this, the data management unit 102 increments “the number of requests in the reference time” in the entry of the processing target by one (S15).

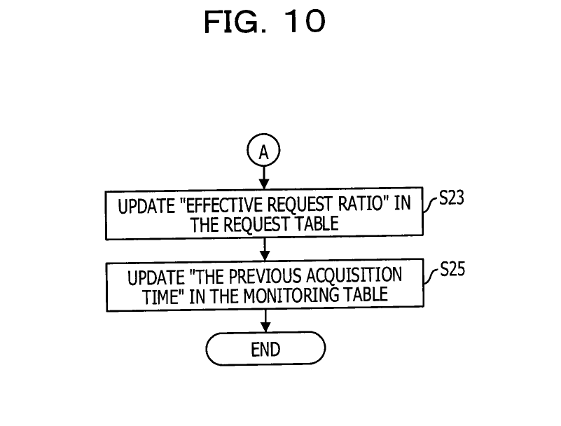

The data management unit 102 identifies an entry including the URI included in the entry of the processing target in the request table. Then, the data management unit 102 increments “the number of requests in the reference time” in the identified entry by one (S17). The processing proceeds to the processing of S23 in FIG. 10 through a connector A.

On the other hand, if time from the “previous acquisition time” in the entry of the processing target to the acquisition time of the packet obtained in S1 is not shorter than the reference time identified in S11 (S13: No), the determination unit 101 notifies the determination result to the data management unit 102.

In response to this, the data management unit 102 increments “the number of requests outside the reference time” in the entry of the processing target by one (S19).

The data management unit 102 identifies an entry including the URI included in the entry of the processing target in the request table. Then, the data management unit 102 increments “the number of requests outside the reference time” in the identified entry by one (S21). The processing proceeds to the processing of S23 in FIG. 10 through the connector A.

A description will be given of FIG. 10. The data management unit 102 updates “effective request ratio” in the entry identified in S11 (S23). As described above, the effective request ratio is calculate by (the number of requests outside the reference time)/((the number of requests in the reference time)+(the number of requests outside the reference time)).

The data management unit 102 updates “the previous acquisition time” in the entry of the processing target by the acquisition time of the packet obtained in S1 (S25). Then the processing is terminated.

By performing the above-described processing, the number of requests decreased by the number of requests in the reference time (that is to say, the number of requests outside the reference time) is obtained. Accordingly, it becomes possible for an operator, or the like of the EC site to more suitably respond to the situation.

If the numeric value of the effective access ratio is lower than a predetermined reference value, a problem might have occurred, for example, it might have taken a long time to display a Web page. Accordingly, the operator of the EC site takes measures in order to improve processing performance, such as increasing the number of CPUs, or the like.

Here, a description will be given of state transition of the monitoring table and the request table using a specific example.

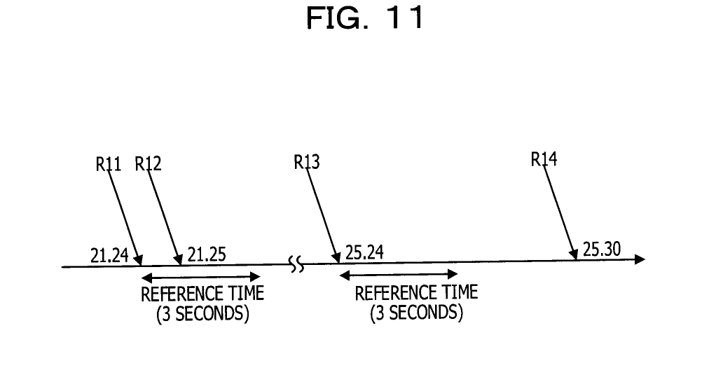

For example, consider a state as illustrated in FIG. 11. In FIG. 11, the horizontal axis represents time, and it is assumed that R11 and R12 are the same requests, and R13 and R14 are the same requests. It is also assumed that R11 is obtained at 21 minutes 24 seconds, R12 is obtained at 21 minutes 25 seconds, R13 is obtained at 25 minutes 24 seconds, and R14 is obtained at 25 minutes 30 seconds. It is also assumed that there have been no requests before obtaining R11.

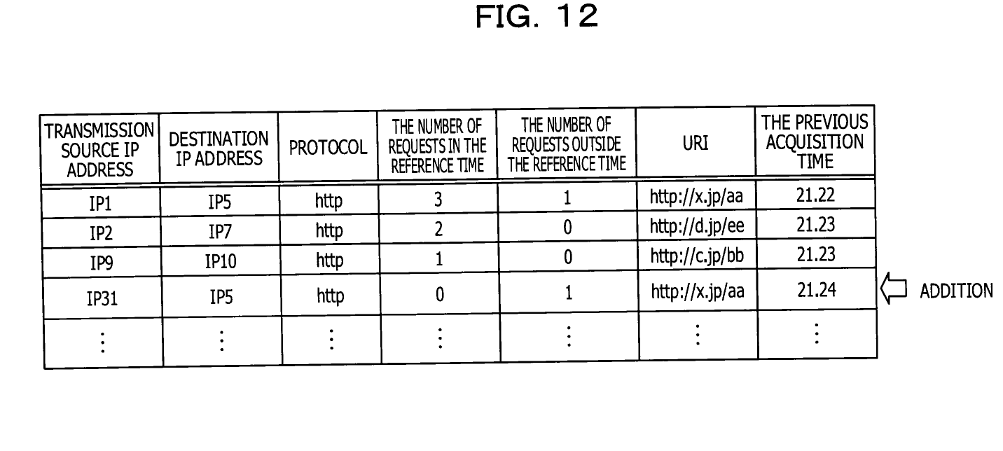

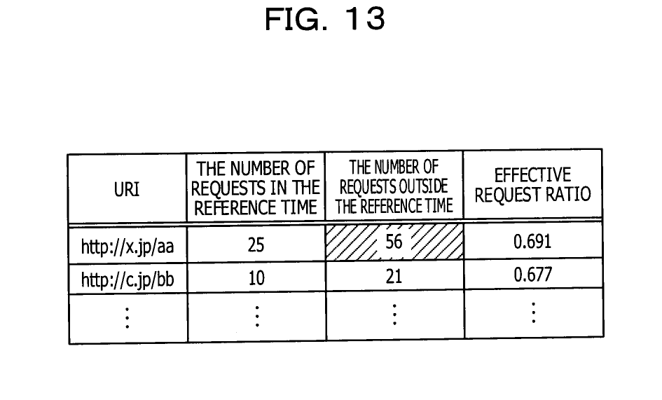

For example, if the request obtained in S1 is R11 in FIG. 11, an entry as illustrated in the fourth row of the monitoring table in FIG. 12 is added in S7. Then, “the number of requests outside the reference time” is incremented by one in S9. In S21, as illustrated in FIG. 13, “the number of requests outside the reference time” in the request table is incremented by one.

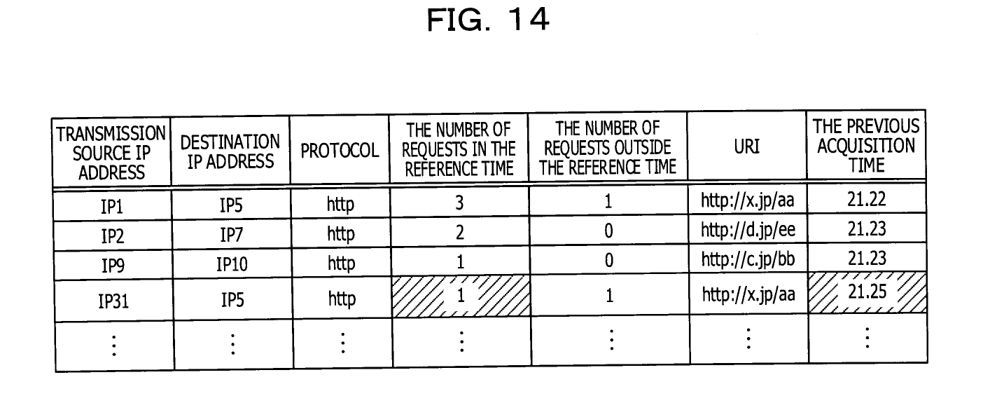

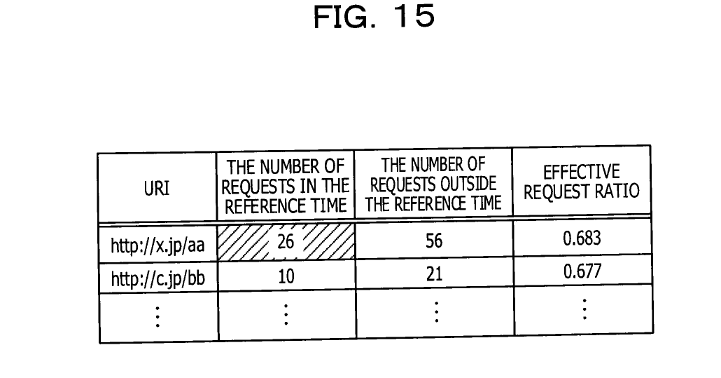

For example, if the request obtained in S1 is R12 in FIG. 11, the monitoring table is updated as illustrated in FIG. 14. Specifically, “the number of requests in the reference time” in the entry in the fourth row is incremented by one in S15. Then, “the previous acquisition time” is changed to 21 minutes 25 seconds in S25. In S17, “the number of requests in the reference time” in the request table is incremented by one as illustrated in FIG. 15.

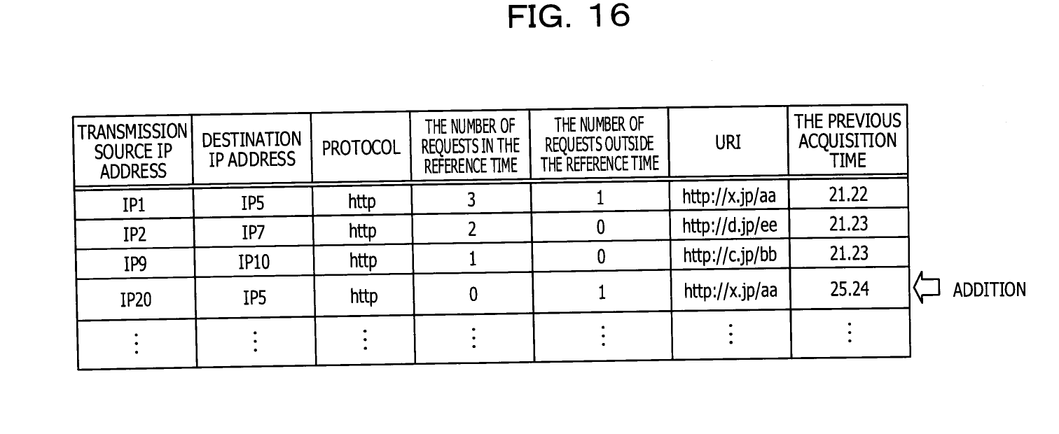

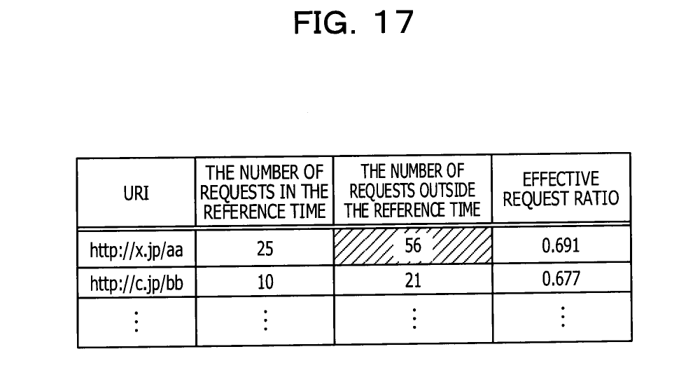

For example, if the request obtained in S1 is R13 in FIG. 11, the entry as illustrated in the fourth row of the monitoring table in FIG. 16 is added in S7, and “the number of requests outside the reference time” is incremented by one in S9. In S21, “the number of requests outside the reference time” in the request table is incremented by one as illustrated in FIG. 17.

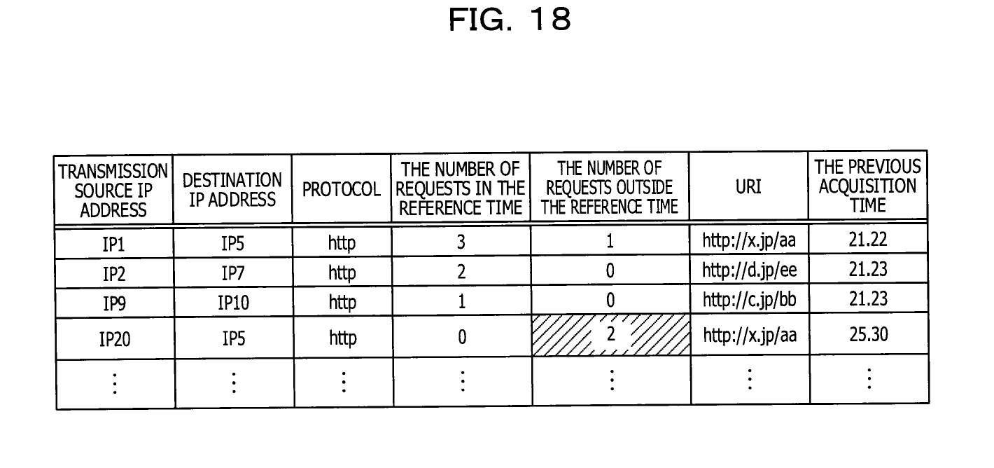

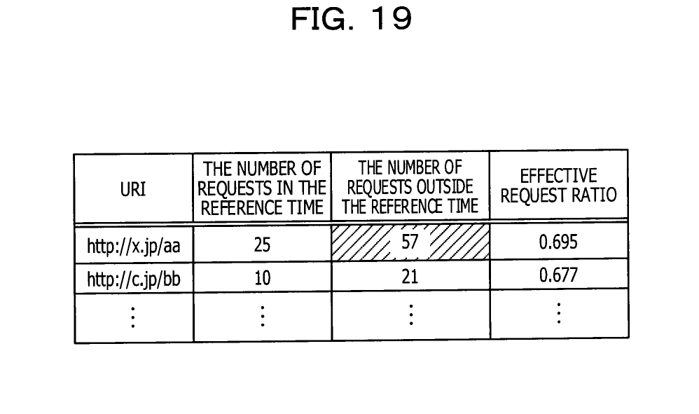

For example, if the request obtained in S1 is R14 in FIG. 11, the monitoring table is updated as illustrated in FIG. 18. Specifically, “the number of requests outside the reference time” in the entry in the fourth row is incremented by one in S19, and “the previous acquisition time” is changed to 25 minutes 30 seconds in S25. In S21, “the number of requests outside the reference time” in the request table is incremented by one as illustrated in FIG. 19.

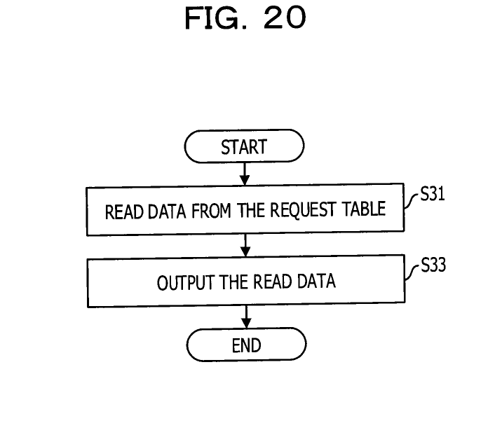

Next, a description will be given of processing performed by the output unit 106 of the monitoring apparatus 10 using FIG. 20.

First, the output unit 106 receives specification of an URI from a user. Then, the output unit 106 reads the number of requests in the reference time, the number of requests outside the reference time, and the effective access ratio that are associated with the specified URI from the request table storage unit 105 (FIG. 20: S31).

The output unit 106 outputs the number of requests in the reference time, the number of requests outside the reference time, and the effective access ratio, which have been read in S31, to the display unit, or the like (S33). Then the processing is terminated.

By performing the processing as described above, it becomes possible for the user of the monitoring apparatus 10 to know the state of the request on the specified URI.

In the above, a description has been given of an embodiment of the present disclosure. However, the present disclosure is not limited to this. For example, the above-described configuration of the functional blocks of the monitoring apparatus 10 sometimes does not match the configuration of the actual program modules.

The above-described structure of each table is an example, and the structure as described above does not have to be employed. Further, in the processing flowcharts, as long as the processing result does not change, it is possible to exchange the processing orders. Further, the processing may be executed in parallel.

If a protocol identifier is obtained from a URI, the monitoring table does not have to be provided with the protocol identifier.

In S5, the transmission source IP address, the destination IP address, the URI, and the protocol identifier are used. However, none of these pieces of information may be used. For example, if it is possible to determine whether the requests are the same or not by the transmission source IP address and the destination IP address, the transmission source IP address, and the destination IP address ought to be used.

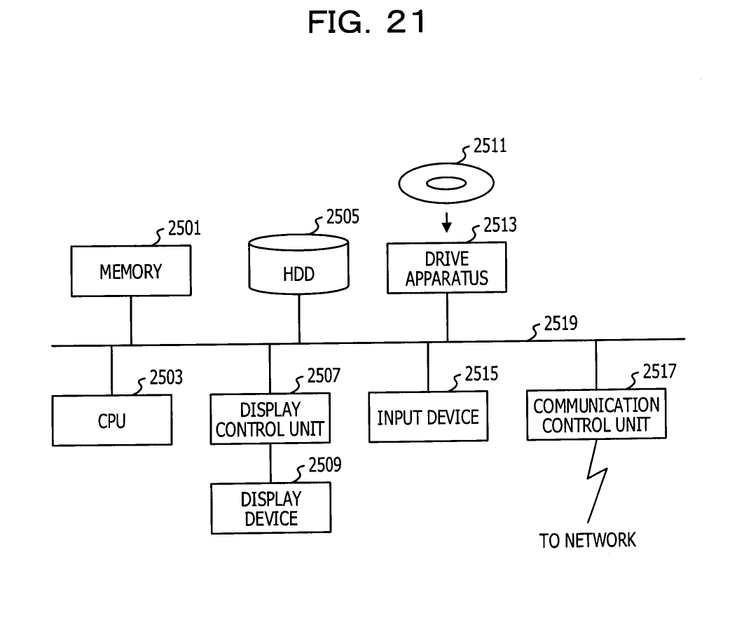

The above-described monitoring apparatus 10, Web server 11, and user terminal 5 are computers. As illustrated in FIG. 21, a memory 2501, a central processing unit (CPU) 2503, a hard disk drive (HDD) 2505, a display control unit 2507 coupled to a display device 2509, a drive apparatus 2513 for a removable disk 2511, an input device 2515, a communication control unit 2517 for connecting to a network are connected through a bus 2519. An operating system (OS), and an application program for executing the processing according to the present embodiments are stored in the HDD 2505. When the application program is executed by the CPU 2503, the application program is read from the HDD 2505 into the memory 2501. The CPU 2503 controls the display control unit 2507, the communication control unit 2517, and the drive apparatus 2513 in accordance with the processing contents of the application program to perform predetermined operation. The data in the middle of the processing is mainly stored in the memory 2501, but may be stored in the HDD 2505. In the embodiments of the present disclosure, the application program for executing the above-described processing is stored in a computer-readable removable disk 2511 for distribution, and is installed from the drive apparatus 2513 into the HDD 2505. The application program is sometimes installed in the HDD 2505 through a network, such as the Internet, or the like, and the communication control unit 2517. Such a computer achieves the above-described various functions by organic cooperation of the hardware, such as the above-described CPU 2503, memory 2501, and the like, and the program, such the OS, the application program, and the like.

The summary of the above-described embodiments according to the present disclosure is as follows.

A packet monitoring apparatus according to an embodiment includes (A) an acquisition unit configured to acquire a packet, (B) a data storage unit configured to store, in association with a combination of packet transmission source information and destination information, acquisition time when the acquisition unit obtained a packet including the transmission source information, and the destination information lastly, and a first counter value, (C) when the acquisition unit obtains a first packet, a determination unit configured to identify acquisition time in association with a combination of the transmission source information and the destination information included in the first packet from the data storage unit, and determine whether the first packet satisfies the first condition, that is to say, a time period from the acquisition time to time when the acquisition unit obtained the first packet is shorter than a predetermined time period, and (D) if determined by the determination unit that the first packet satisfies the first condition, a data management unit configured to increase, by a predetermined value, the first counter value stored in the data storage unit and associated with a combination of the transmission source information and the destination information included in the first packet.

If a certain packet was transmitted, and then the same packet is transmitted before a predetermined time has passed, there is a possibility that the latter packet is mistakenly transmitted, or the like. Accordingly, the latter packet ought to be handled differently from a normal packet. By carrying out the above-described procedure, the number of packets satisfying the first condition is reflected on the first counter value, and thus it becomes possible to suitably exclude the number of packets that is not to be counted, and to correctly count the number of requests to be counted.

The above-described data storage unit (b1) may further store the second counter value in association with a combination of transmission source information and destination information of a packet. Then, if the determination unit determines that (d1) the first packet does not satisfies the first condition, the above-described data management unit may increase the second counter value, which is stored in the data storage unit, and is associated with a combination of the transmission source information and the destination information included in the first packet by a predetermined value. In this manner, the number of effective packets becomes reflected on the second counter value.

(E) The second data storage unit that stores a third counter value in association with a uniform resource identifier (URI) may further be provided. Then, (d2) if the determination unit determines that the first packet satisfies the first condition, the above-described data management unit may increase the third counter value, which is stored in the second data storage unit, and is associated with the URI included in the first packet by a predetermined value. In this manner, it becomes possible to evaluate the number of packets to be excluded for each URI.

The above-described second data storage unit may store a fourth counter value in association with a URI. Then, (d3) if the determination unit determines that the first packet does not satisfy the first condition, the above-described data management unit may increase the fourth counter value, which is stored in the second data storage unit, and is associated with a URI included in the first packet by a predetermined value. In this manner, it becomes possible to evaluate the number of effective packets for each URI.

The above-described data management unit may calculate (d4) a value produced by dividing the fourth counter value by the sum of the third counter value and the fourth counter value. In this manner, it is possible to obtain an effective packet ratio, and thus it becomes possible to take suitable measures.

The above-described data storage unit may store (b2) acquisition time in association with the transmission source information and the destination information of a packet, and a URI. Then, (c1) when the acquisition unit obtains a first packet, the above-described determination unit may identify acquisition time associated with the transmission source information and the destination information included in the first packet, and the URI. In the case of a protocol using a URI, it becomes possible to increase a degree of certainty of the same packet.

If (c2) there are no combinations of the transmission source information and the destination information included in the first packet in the data storage unit, the above-described determination unit may store time when the first packet is obtained, and an initial value of the first counter into the data storage unit in association with a combination of the transmission source information and the destination information included in the first packet. In this manner, it becomes possible to handle in the case of receiving a packet having the same combination of the transmission source information and the destination information once again.

The above-described determination unit (c3) may change the predetermined time in accordance with a protocol identifier included in the first packet. In this manner, it becomes possible to suppress a failure of obtaining a suitable result, which is caused by having a too long predetermined time or a too short predetermined time, for example.

The above-described data management unit may (d5) change the acquisition time associated with the combination of the transmission source information and the destination information included in the first packet to the time when the acquisition unit obtained the first packet. In this manner, it becomes possible to perform suitable processing on the packet obtained the next time.

The above-described predetermined value may be 1.

The above-described packet may be a request packet.

A packet monitoring method according to another embodiment includes (F) when a first packet is obtained, from the data storage unit storing the acquisition time when a packet including the transmission source information and the destination information is obtained lastly in association with a combination of transmission source information and destination information of the packet, and the first counter value, identifying the acquisition time associated with the combination of transmission source information and the destination information included in the first packet, (G) determining whether the first packet satisfies the first condition in which a time period from the identified acquisition time to time when the first packet is obtained is shorter than a predetermined time, and (H) if the determination unit determines that the first packet satisfies the first condition, increasing the first counter value that is stored in the data storage unit, and associated with a combination of the transmission source information and the destination information included in the first packet by a predetermined value.

It is possible to create a program for causing a computer to perform the processing by the above-described method. The program is stored in a computer-readable storage medium, such as a flexible disk, a CD-ROM, a magneto-optical disc, a semiconductor memory, a hard disk, and the like, or a storage device. In this regard, the intermediate processing result is temporarily stored in a storage device, such as the main memory, or the like, for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet monitoring method executed by a packet monitoring apparatus, the packet monitoring method comprising:
storing acquisition time indicating time when a packet including the transmission source information and the destination information is obtained lastly, and a first counter value into a first memory, in association with a combination of transmission source information and destination information of a plurality of packets;
receiving a first packet;
extracting acquisition time associated with a combination of transmission source information and destination information included in the first packet from the first memory;
determining whether a time period from the extracted acquisition time to acquisition time of the first packet is shorter than a predetermined time; and
increasing the first counter value stored in the first memory and associated with the combination of transmission source information and destination information included in the first packet by a predetermined value when it is determined that the time period is shorter than the predetermined time.

2. The packet monitoring method according to claim 1, further comprising:
storing a second counter value into the first memory, in association with a combination of transmission source information and destination information of a packet; and
increasing the second counter value stored in the first memory and associated with the combination of transmission source information and destination information included in the first packet by a predetermined value when it is determined that the time period is equal to or longer than the predetermined time.

3. The packet monitoring method according to claim 1, further comprising:
storing a third counter value into a second memory in association with a uniform resource identifier (URI); and
increasing the third counter value stored in the second memory and associated with the URI included in the first packet by a predetermined value when it is determined that the time period is shorter than the predetermined time.

4. The packet monitoring method according to claim 3, further comprising:
storing a fourth counter value in association with the URI into a second data storage unit; and
increasing the fourth counter value stored in the second data storage unit and associated with the URI included in the first packet by a predetermined value when it is determined that the time period is equal to or longer than the predetermined time.

5. The packet monitoring method according to claim 3, further comprising:
calculating a value by dividing the fourth counter value by a sum of the third counter value and the fourth counter value; and
storing the calculated value into the second memory.

6. The packet monitoring method according to claim 1, wherein
the storing into the first memory includes storing the acquisition time into the first memory in association with a combination of packet transmission source information of and destination information and a URI,
the extracting includes extracting acquisition time associated with transmission source information and destination information included in the first packet, and a URI.

7. The packet monitoring method according to claim 1, further comprising:
storing time when the first packet is obtained, and an initial value of the first counter into the first memory in association with a combination of transmission source information and destination information included in the first packet when there are no combinations of transmission source information and destination information included in the first packet in the first memory.

8. The packet monitoring method according to claim 1, further comprising:
changing the predetermined time in accordance with a protocol identifier included in the first packet.

9. A packet monitoring apparatus comprising:
a first memory configured to store, in association with a combination of transmission source information and destination information of a plurality of packets, acquisition time indicating time when a packet including the transmission source information and the destination information is obtained lastly, and a first counter value; and
a processor coupled to the first memory and configured to:
receive a first packet,
extract acquisition time associated with a combination of transmission source information and destination information included in the first packet from the first memory,
determine whether a time period from the extracted acquisition time to acquisition time of the first packet is shorter than a predetermined time, and
increase the first counter value stored in the first memory and associated with the combination of transmission source information and destination information included in the first packet by a predetermined value when it is determined that the time period is shorter than the predetermined time.

10. The packet monitoring apparatus according to claim 9, wherein the processor is further configured to:
store a second counter value into the first memory, in association with a combination of transmission source information and destination information of a packet; and
increase the second counter value stored in the first memory and associated with the combination of transmission source information and destination information included in the first packet by a predetermined value when it is determined that the time period is equal to or longer than the predetermined time.

11. The packet monitoring apparatus according to claim 9, wherein the processor is further configured to:
store a third counter value into a second memory in association with a uniform resource identifier (URI); and
increase the third counter value stored in the second memory and associated with the URI included in the first packet by a predetermined value when it is determined that the time period is shorter than the predetermined time.

12. The packet monitoring apparatus according to claim 11, wherein the processor is further configured to:
store a fourth counter value in association with the URI into a second data storage unit; and
increase the fourth counter value stored in the second data storage unit and associated with the URI included in the first packet by a predetermined value when it is determined that the time period is equal to or longer than the predetermined time.

13. The packet monitoring apparatus according to claim 11, wherein the processor is further configured to:
calculate a value by dividing the fourth counter value by a sum of the third counter value and the fourth counter value; and
store the calculated value into the second memory.

14. A non-transitory computer-readable storage medium storing a program that causes one or more processors included in a computer to execute a process, the computer including a first memory configured to store acquisition time indicating time when a packet including the transmission source information and the destination information is obtained lastly, and a first counter value, in association with a combination of transmission source information and destination information of a plurality of packets, the process comprising:
receiving a first packet,
extracting acquisition time associated with a combination of transmission source information and destination information included in the first packet from the first memory,
determining whether a time period from the extracted acquisition time to acquisition time of the first packet is shorter than a predetermined time, and
increasing the first counter value stored in the first memory and associated with the combination of transmission source information and destination information included in the first packet by a predetermined value when it is determined that the time period is shorter than the predetermined time.
